(19) United States
(12) Patent Application Publication
(10) Pub. No.: US 2006/0010117 A1
(43) Pub. Date: Jan. 12, 2006

(54) Methods and systems for interactive search

(75) Inventors: Eric Bonabeau, Winchester, MA (US); Paolo Gaudiano, Essex, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Icosystem Corporation, Cambridge, MA (US)

(21) Appl. No.: 11/176,968

(22) Filed: Jul. 6, 2005

Related U.S. Application Data
(60) Provisional application No. 60/585,807, filed on Jul. 6, 2004.

(51) Int. Cl. G06F 17/30

(52) U.S. Cl. 707/3

(57) ABSTRACT

In one example, a user is presented with information (e.g., the results of a search provided by a search component executing a search query). The user then subjectively evaluates the information presented pursuant to some metric (e.g., desirable/positive, undesirable/negative, neutral) to provide user feedback. The user feedback is evaluated using one or more evolutionary algorithms to generate a new search query, which may be executed by any one of a number of conventional search components (or a commercial or non-commercial website powered by a search component) to provide new information to the user. The foregoing process may be iterated any number of times, for example, until a user identifies desirable information. In some implementations, additional user interaction is permitted, such as modification of one or more descriptors/characteristics associated with presented information, and/or modification of a search query generated by the evolutionary algorithm(s).

### CROSS-REFERENCE TO RELATED APPLICATIONS

The present application claims the benefit under 35 U.S.C. § 119(e) of U.S. Provisional Patent Application Ser. No. 60/585,807, filed on Jul. 6, 2004, entitled “Methods and Systems for Interactive Search,” which is hereby incorporated herein by reference.

### FIELD OF THE DISCLOSURE

The disclosed methods and apparatus systems relate generally to searching for information from a database.

### BACKGROUND

Search engines assist a user in identifying information that may be stored on a computer server or other information storage media. Generally, the information may be is in the form of a database (e.g., any structured database, any database of objects with tags or descriptors). The information may include, for example, various web page content, photographs, goods or services for sale, or any other item that can be represented and stored in electronic format. Some examples of commonly used search engines include, but are not limited to Yahoo®, MSN®, Google™, amazon.com®, a9.com, AOL®, Lycos®, LookSmart®, Altavista™, Ask Jeeves®, Orbitz™, Travelocity®, expedia.com®, and flickr.com™.

Search engines typically require the user to enter one or a plurality of keywords, and in some cases, to specify one or a plurality of Boolean operators to determine the logical relationship between the pluralities of keywords. This provision of one or more keywords and/or optional Boolean operators is referred to as the “search query.” A search engine executes one or more algorithms which act on the search query to identify one or a plurality of items of information that satisfy the search query (this information is commonly referred to as “search results”). The search engine generally returns the results of the search algorithm by presenting them to the user through some form of a user interface (e.g. display). In some instances, when a plurality of search results is available, the search engine may further determine which specific results to present to the user according to some criteria (e.g. ranking, optimization). The user is then able to select one or a plurality of search results. If none of the results is satisfactory, or if additional results are sought, the user can select to view additional results, or the user can refine or modify the search query, for example, by adding or removing one or more keywords and/or optional Boolean operators.

In addition to conventional search engines, which may execute various proprietary algorithms to process search queries and provide results according to some type of ranking of optimization process, a search query may be executed by a web directory service. Unlike a search engine, a web directory service that is capable of processing a search query returns to the user lists and categories of web sites, as search results, without necessarily ranking, promoting or optimizing the list of web sites. One example of a web directory service includes the Open Directory Project, hosted and administered by Netscape Communication Corporation (see http://dmoz.org).

### SUMMARY

Search engines and web directory services (also referred to herein as “search components”) generally are designed to identify as closely as possible a specific piece (or specific pieces) of information that the user is seeking. To provide satisfactory results, the search component typically relies on the ability of the user to provide a “good” search query. Applicants have recognized and appreciated, however, that there may be a situation in which the user is not able to create a good search query. Examples of such a situation include, but are not limited to, (a) when the user does not know exactly what he or she is searching for; and (2) when there is a very large number of results that satisfy the user's initial search query to the search component. In these and perhaps other instances, the user can become frustrated with the inability of the search component to provide a meaningful set of results; in effect, a traditional search query including one or more keywords and/or Boolean operators does not render satisfactory results.

Applicants have also recognized and appreciated that for at least some search applications (including the examples provided above in which the user does not know exactly what he or she is looking for, or when there is a large number of results), affording the user with the ability to subjectively evaluate search results, or otherwise interact with the search component, may facilitate the generation of significantly more satisfactory search results in an iterative fashion.

In view of the foregoing, various embodiments of the present disclosure are directed to methods and apparatus for interactive searching. In one exemplary embodiment, a user is presented with information (e.g., the results of a search provided by a search component executing a search query). The user then subjectively evaluates the information presented pursuant to some metric (e.g., desirable/positive, undesirable/negative, neutral) to provide user feedback. The user feedback is evaluated using one or more evolutionary algorithms to generate a new search query, which may be executed by any one of a number of conventional search components (or a commercial or non-commercial website powered by a search component) to provide new information to the user. The foregoing process may be iterated any number of times, for example, until a user identifies desirable information. In some implementations, additional user interaction is permitted, such as modification of one or more descriptors/characteristics associated with presented information, and/or modification of a search query generated by the evolutionary algorithm(s).

In various embodiments, the disclosed methods and apparatus enable a user to search for information when the search may not be easily expressed through keywords and/or Boolean operators, and/or when the desired result is not known a priori and/or may include a subjective evaluation on behalf of the user.

In one exemplary implementation, the disclosed methods and apparatus employ an interactive search function that begins by presenting the user with a plurality of items of information through some form of user interface (e.g., a computer display). The user is able to assign one or more subjective values to one or more items (e.g., via a computer mouse or keyboard), which are then evaluated to formulate a new search query. Based on the new search query, the interactive search function identifies a new set of items that match more closely the subjective evaluation of the user, and presents the new items to the user through the user interface. The user again is able to assign a subjective value to any of the items, and the process is repeated. As this interactive search process continues, the disclosed methods and apparatus provide the user with results that are increasingly satisfactory to the user.

In one illustrative embodiment, a user is searching for a gift. The user may begin with little idea of a desired gift. A user interface (e.g., including a conventional computer display and selection device such as a mouse or keyboard) may be configured to display to the user a grid of images representing an initial selection of gift items, generated either randomly or pursuant to some previous query executed by a search component. Optionally, the user can specify some basic data about the intended recipient of the gift (i.e., one or more constraints), to formulate a narrower initial selection of gifts. Via the user interface, the user assigns a subjective value to one or more candidate gifts (e.g., by clicking on one or more icons next to each image representing satisfaction or dissatisfaction). The user then clicks a button to initiate a new search, based at least in part on the assigned subjective value(s), to present a new set of gift images. The user continues this process until a satisfactory gift is found. Based on the foregoing general process, it should be readily appreciated that a user may similarly search for items other than gifts, some examples of which include, but are not limited to, a variety of goods or services for purchase, a venue for a vacation, a parcel of real estate, an image from an image library, a filter and its parameter settings to produce an artistic modification of an image, and other items.

The disclosed methods and apparatus thus provide ways of searching for information when the specific item being sought is not known a priori or when there is a vast number of items that could satisfy the user. The disclosed methods and apparatus may be employed with virtually any search component (e.g. search engine or web directory service) or in any other environment in which search techniques are commonly used (e.g., to search databases stored on some medium). The disclosed methods and apparatus allow the user to conduct a search in an interactive (and iterative) fashion, providing subjective evaluation to guide the search.

In sum, one embodiment of the present disclosure is directed to a method, comprising acts of: A) evaluating first information to provide first feedback on the first information; and B) evaluating the first feedback using at least one evolutionary algorithm to generate a search query.

Another embodiment is directed to a computer-readable medium having computer-readable signals stored thereon that define instructions which, as a result of being executed by a computer, instruct the computer to perform a method comprising acts of: A) permitting a user to evaluate first information to provide first feedback on the first information; and B) evaluating the first feedback using at least one evolutionary algorithm to generate a search query.

Another embodiment is directed to a method performed using a computer system having a user interface including a display and a selection device. The method comprises is acts of: A) displaying first information on the display; B) permitting a user to evaluate the first information via the selection device to provide first feedback on the first information; and C) evaluating the first feedback using at least one evolutionary algorithm to generate a search query.

Another embodiment is directed to a system, comprising at least one first component configured to convey first information to a user, at least one second component configured to permit the user to evaluate the first information to provide first feedback on the first information, and at least one processor configured to evaluate the first feedback using at least one evolutionary algorithm to generate a search query.

Another embodiment is directed to a search method, comprising acts of: A) executing a first search query to generate first information, the first information including a plurality of items, each item of the plurality of items being associated with at least one characteristic; B) encoding the at least one characteristic associated with each item as at least one gene of a genetic string associated with each item; C) permitting a user to assign a subjective value to at least one item of the plurality of items to provide first feedback; D) applying at least one evolutionary algorithm to at least the genetic string associated with the at least one item, based on the first feedback, to generate a second search query; and E) executing the second search query to generate second information.

Another embodiment is directed to a computer-readable medium having computer-readable signals stored thereon that define instructions which, as a result of being executed by a computer, instruct the computer to perform a search method comprising acts of: A) executing a first search query to generate first information, the first information including a plurality of items, each item of the plurality of items being associated with at least one characteristic; B) encoding the at least one characteristic associated with each item as at least one gene of a genetic string associated with each item; C) permitting a user to assign a subjective value to at least one item of the plurality of items to provide first feedback; D) applying at least one evolutionary algorithm to at least the genetic string associated with the at least one item, based on the first feedback, to generate a second search query; and E) executing the second search query to generate second information.

Another embodiment is directed to a search method performed using a computer system having a user interface including a display and a selection device. The search method comprises acts of: A) executing a first search query to generate first information, the first information including a plurality of items, each item of the plurality of items being associated with at least one characteristic; B) encoding the at least one characteristic associated with each item as at least one gene of a genetic string associated with each item; C) displaying the first information on the display; D) permitting a user to assign, via at least the selection device, a subjective value to at least one item of the plurality of items to provide first feedback; E) applying at least one evolutionary algorithm to at least the genetic string associated with the at least one item, based on the first feedback, to generate a second search query; and F) executing the second search query to generate second information.

Another embodiment is directed to a system, comprising a search component configured to execute a first search query to generate first information, the first information including a plurality of items, each item of the plurality of items being associated with at least one characteristic, a first component configured to convey the first information to a user, and a second component configured to permit the user to assign a subjective value to at least one item of the plurality of items to provide first feedback. The system further comprises at least one third component configured to encode the at least one characteristic associated with each item as at least one gene of a genetic string associated with each item, and apply at least one evolutionary algorithm to at least the genetic string associated with the at least one item, based on the first feedback, to generate a second search query. The search component is further configured to execute the second search query to generate second information.

The present disclosure also incorporates herein by reference the entirety of U.S. non-provisional application Ser. No. 10/815,321, filed Apr. 1, 2004, entitled “Methods and Systems for Interactive Search.”

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

FIG. 1 is an overview of a user performing an interactive search process, according to one embodiment of the present disclosure;

FIG. 2 is a flow diagram of the interactive search process indicated in FIG. 1, according to one embodiment of the present disclosure; and

FIGS. 3a, 3b and 3c provide illustrations of some of the concepts discussed in connection with FIGS. 1, and 2, according to one embodiment of the present disclosure;

FIGS. 4a, 4b, 5a and 5b provide illustrations of some of the concepts discussed in connection with FIGS. 1, and 2, according to another embodiment of the present disclosure;

FIGS. 6a and 6b provide illustrations of some of the concepts discussed in connection with FIGS. 1, and 2, according to another embodiment of the present disclosure.

### DETAILED DESCRIPTION

To provide an overall understanding, certain illustrative embodiments will now be described; however, it will be understood by one of ordinary skill in the art that the apparatus and methods described herein can be adapted and modified to provide apparatus and methods for other suitable applications and that other additions and modifications can be made without departing from the scope of the systems and methods described herein.

Unless otherwise specified, the illustrated embodiments can be understood as providing exemplary features of varying detail of certain embodiments. Therefore, unless otherwise specified, features, components, modules, and/or aspects of the illustrations can is be otherwise combined, separated, interchanged, and/or rearranged without departing from the disclosed systems or methods.

Interactive search is a way of presenting information to a user and letting the user provide feedback to improve the quality of the search until a desirable item is found. Interactive search differs fundamentally from other search methods in that it is geared toward searches in which the user does not exactly know what he is looking for, or when a normal search may return a vast number of items. In both of these circumstances, Applicants have recognized and appreciated that identifying the specific item(s) of interest to the user may be facilitated by an evaluation of the user's subjective preferences.

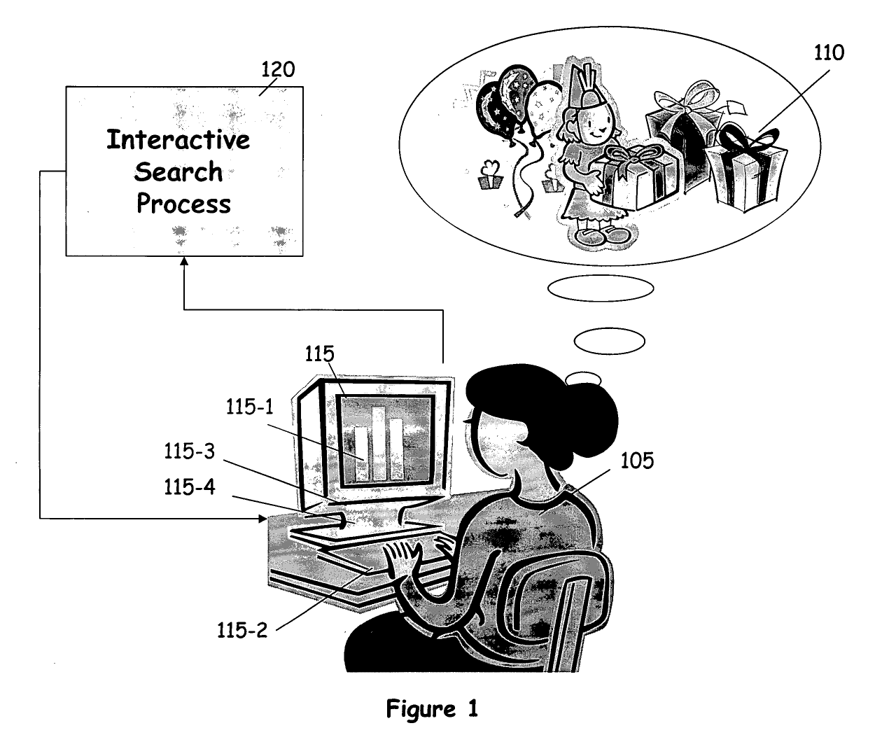

One exemplary embodiment of the disclosed methods and apparatus is described in overview in FIG. 1. In this embodiment, a user 105 wishes to purchase a gift 110, but does not have a specific gift in mind. The user may employ a computer 115, including a display 115-1, a selection device 115-2 (e.g., a keyboard or a mouse), and one or more processors 115-3, to initiate a search query via a search component (e.g., a search engine or web directory service), which then presents to the user information regarding gift items, pursuant to the search query. In one aspect, since it is assumed the user does not have specific gift criteria in mind, the initial search query may indeed by quite crude or vague (e.g., the query might be based on the gender and/or age of the person for whom the gift it intended). Alternatively, the information regarding potential gift items may be generated randomly, for example, from a merchant's database, and/or the information may be selected. The user 105 then employs an interactive search process 120, as discussed in greater detail below, to actively evaluate her search options in accordance with her subjective preferences. She continues using the interactive search process 120 until she finds a desired gift item.

It should be appreciated that although the exemplary process depicted in FIG. 1 illustrates the selection of a gift, virtually any type of item identified in some manner in a searchable database may be searched for by the user in a similar interactive manner, according to various embodiments of the present disclosure.

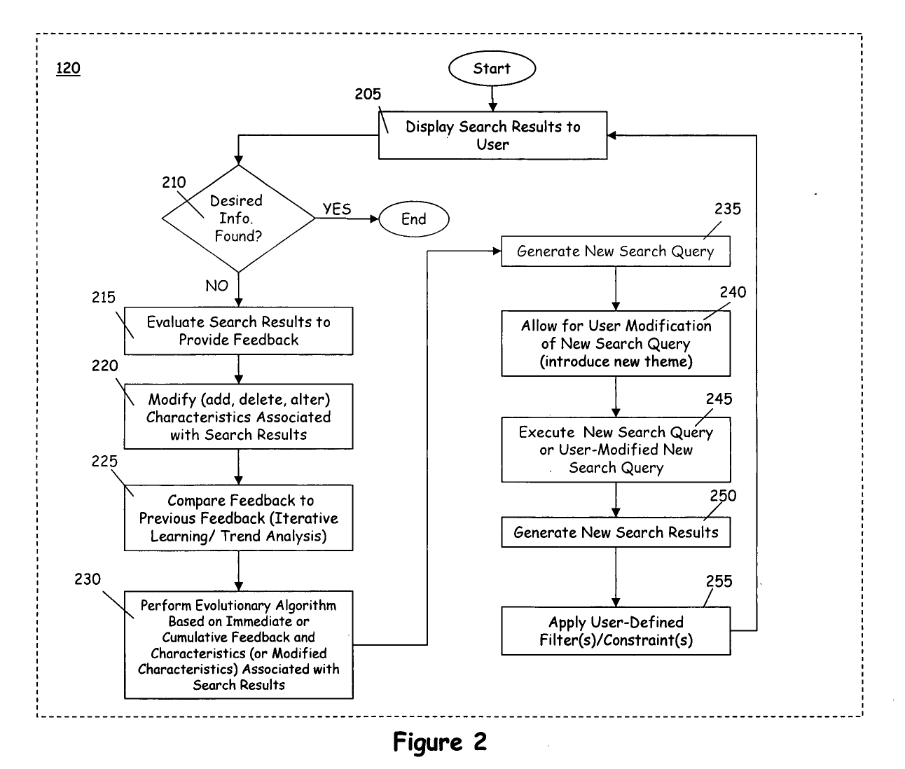

FIG. 2 illustrates in somewhat greater detail the interactive search process 120 indicated in FIG. 1, according to one embodiment of the present disclosure. As discussed further below, the process outlined in FIG. 2 includes some optional steps or acts that are not necessarily required in all embodiments of the present disclosure. Thus, the description below should be understood as including various concepts that may be optionally included in different implementations of methods and apparatus according to the present disclosure.

In the embodiment illustrated in FIG. 2, the interactive search process 120 begins in block 205 by displaying search results to the user 105 shown in FIG. 1. In one aspect of this embodiment, the search results may be randomly generated. In other aspects, a search component may execute a previous search query to generate the search results. Examples of such search components include, but are not limited to, Yahoo®, MSN®, Google™, amazon.com®, a9.com, AOL®, Lycos®, LookSmart®, Altavista™, Ask Jeeves®, Orbitz™, Travelocity®, expedia.com®, flickr™, and the Open Directory Project.

In another embodiment not specifically depicted in FIG. 2, an interactive search process may more generally provide information relating to initial search results by representing all or a portion of the information as any one of a number of perceivable indications to the user 105. For example, all or a portion of the information relating to the search results may be provided as one or more audible or visible indications. With respect to visual indications, as indicated in block 205 of FIG. 2, all or a portion of the information may be displayed textually and/or graphically, including graphic displays of a plurality of images or diagrams representing respective items of information (e.g., individual items in the search results). In one exemplary implementation discussed further below, respective items in the search results may be graphically displayed to the user as a two dimensional grid of images or diagrams representing the items.

In block 210 of FIG. 2, the user decides whether the initial search results provided in block 205 contain desired information (e.g., a desired item in the search results). If so, the user can opt to end the process. Otherwise, the user may continue the process in block 215.

In block 215 of FIG. 2, the user is permitted to evaluate the search results to provide feedback. In one exemplary implementation, the user may evaluate the search results, for example, by utilizing a mouse, keyboard or other selection device in combination with evaluation options presented to the user via a computer display. In one aspect, the user feedback may include assigning a degree of randomness, based on evaluating a plurality of items in the search results, for generating a new search query according to subsequent acts in the process detailed below. In another aspect, the user feedback may include assigning a subjective value (also referred to as a “fitness” measure, or weight, or grade, or rank) to one or more items in the search results. In one exemplary implementation, one or more subjective values assigned by the user may be represented in some fashion on the display, in coordination with a representation of an item to which the subjective value is assigned. For example, in one embodiment, items of the search results may be graphically displayed as a two dimensional grid of images or diagrams, and subjective values assigned to different item may be respectively represented in some fashion on the grid of images or diagrams.

In other aspects, the user may select a subjective value from at least two or more possible subjective values to indicate the relative desirability of a given item in the search results. For example, by merely selecting (highlighting) a given item, the user may indicate that item's desirability. Non-selected (non-highlighted) items may then be considered as undesirable. In another aspect, the user may assign a positive value to desirable items, a negative value to undesirable items, and one or more items not particularly addressed by the user may be assigned a neutral value. In yet another aspect, the user may assign a subjective value for a given item from within a range of possible values between some minimum value and some maximum value (e.g., a degree of fitness, weight, grade or rank). In yet another aspect, a subjective value for one or more items may be assigned based on a user's response time to comment on a given item. The forgoing examples are provided primarily for purposes of illustration, and are not intended as limiting. Additionally, as discussed above, various options for assigning a subjective value to one or more items in the search results may be facilitated via the use of a computer display is and/or selection device (e.g., keyboard, mouse).

In block 220 of the interactive search process illustrated in FIG. 2, the user may be given the option to modify (e.g., add, delete, alter) one or more characteristics associated with the search results. In one embodiment, each item in the search results may be associated with one or more characteristics. In one aspect, one or more characteristics associated with each item may include any descriptor for the item made available via a given search component's application program interface (API). Examples of such characteristics associated with a given item in the search results may include, but are not limited to, one or more tags (which may include one or more keywords, comments, URL links, and/or XML information), one or more classification-oriented identifiers, one or more categorization-oriented identifiers, and one or more semantic web-based identifiers. More specifically, one or more characteristics associated with a given item may include one or more taxonomy-related identifiers for the item, one or more ontology-related identifiers, and/or one or more folksonomy-related identifiers (e.g., “people who bought book X also bought book Y”) (the terms “taxonomy,” “ontology,” and “folksonomy” are intended to have the respective meanings that would be readily associated with them by one of ordinary skill in the relevant arts).

In block 225 of FIG. 2, the process may optionally compare the present feedback provided by the user to previous feedback provided by the user, assuming that the interactive search process 120 shown in FIG. 2 has completed at least one loop of iteration. By optionally memorizing previous feedback, the process 120 may employ adaptive learning techniques (e.g., trend analysis) to ultimately shape the generation of a new search query. In one aspect of an implementation employing such adaptive learning techniques, one or more subjective values assigned by the user to one or more corresponding items in the search results may be modified prior to further processing (e.g., averaging subjective values from feedback gathered over multiple iterations, weighted averaging of subjective values, etc.).

In block 230 of the process 120 shown in FIG. 2, one or more evolutionary algorithms are performed based on the immediate user feedback (e.g., one or more subjective values assigned in block 215), or cumulative feedback provided by block 225. Again, the subjective value(s) constituting the user feedback may be viewed in terms of assigning a “fitness” measure or desirability in connection with one or more items in the initial search results.

In one embodiment, to facilitate the execution of one or more evolutionary algorithms in block 230, one or more characteristics associated with each item, or one or more characteristics that have been modified by a user (as discussed above in connection with block 220), are encoded as one or more “genes” in a genetic string associated with each item. Hence, each item in the search results may be associated with a corresponding genetic string that includes one or more genes, wherein each gene represents a characteristic of the item (e.g., a tag, keyword, comment, identifier, descriptor, attribute, etc., as discussed above).

In block 230, once one or more such genetic strings are assembled, the evolutionary algorithm including one or more genetic operators is then applied to the one or more genetic strings associated with one or more items. Genetic strings are considered in the evolutionary algorithm based on their corresponding “fitness,” i.e., the user feedback (subjective value) assigned to the one or more items with which the strings are associated, to generate a new search query in block 235.

In various aspects, the genetic operators applied by an evolutionary algorithm in block 230 may include, but are not limited to, a selection operator, a mutation operator, a recombination operator, a crossover operator, a directed operator, a constraint operator, and a preservation (elitism) operator. For purposes of the present disclosure, and as would be readily understood by one of ordinary skill in the relevant arts, an evolutionary algorithm (also referred to as a genetic algorithm or program) generally is concerned with three possible factors, namely: 1) a population of one or more “parents” that may be randomly initialized (e.g., in the process 120, a “parent” may be considered as a genetic string associated with a given item in the search results); 2) one or more mutation operators capable of altering at least one “parent” to a “neighboring solution” (this process also may be referred to as a “local search operator”); and 3) a recombination operator which can recombine genetic strings of two parents into a “child” that inherits traits from both parents (this process also may be referred to as a “global search operator”).

In connection with evolutionary algorithms as applied herein, an exemplary mutation operation may be generally understood to potentially introduce randomness to the process, as a mutation operator may be configured to delete one or more genes of a given genetic string, or add one or more random genes to a given genetic string. Exemplary recombination operations can include reproduction, mutation, preservation (e.g., elitism) and/or crossover, where crossover can be understood to be the combination of two individuals (the “parents”) to produce one or more offspring (the “children”) (i.e., a crossover operator may be configured to combine genes of at least two given genetic strings to produce one or more offspring). Those of ordinary skill will recognize that a crossover operator may include asexual crossover and/or single-child crossover. Accordingly, crossover can be more generally understood to provide genetic material from a previous generation to a subsequent generation. In one exemplary evolutionary algorithm that may be employed in an implementation of the process 120 shown in FIG. 2, at least one crossover operator is applied to at least two genetic strings respectively associated with two items in the search results to generate an offspring, and at least one mutation operator is subsequently applied to the offspring to generate a new search query.

Variations of evolutionary algorithms, and different genetic operators used in various combinations, several of which are suitable for the process 120 shown in FIG. 2, are well known in the art. Accordingly, the examples presented herein are discussed primarily for purposes of illustration, and are not intended as limiting. In some exemplary implementations, one or more evolutionary algorithms are designed a priori to act on one or more genetic strings, and may not be altered by the user. In other implementations, the user may be provided with the capability to design their own evolutionary algorithm by selecting one or more genetic operators to apply to one or more genetic strings input to the algorithm, as well as an execution sequence for multiple genetic operators. The user's interaction with the process 120 then may include evaluation of fitness for a particular item, modification of one or more of an item's characteristics (genes) and evolutionary algorithm design.

As discussed above, in block 235 of FIG. 2, a new search query is generated by one or more evolutionary algorithms. As indicated in block 240, in one exemplary implementation the user optionally may be allowed to modify the new search query to introduce a new theme (e.g., one or more new search terms) not present in the generated search query. In one aspect of this implementation, the new search query generated by the one or more evolutionary algorithms would be displayed to the user (e.g., via a computer display) for modification.

In block 245 of the process 120 outlined in FIG. 2, the new search query generated in block 235, or a user-modified new search query optionally provided in block 240, is executed by a search component (e.g., search engine or web directory service), and new search results are generated in block 250. In one exemplary implementation, the same search component that was employed to initially generate search results in block 205 is again employed to execute a search query in block 245. In one aspect, the new search query or user-modified new search query may be passed to the search component via the search component's application programming interface (API).

Once new search results are generated in block 250, block 255 indicates that the user optionally may define a filter that is applied to the newly generated results. For example, in one exemplary implementation, the user may define one or more constraints (e.g., provide only those results that cost less than $100, provide only green items, provide only 10 items) to selectively filter out possibly undesirable results from the newly generated results.

As indicated in FIG. 2, the unfiltered results generated in block 250, or the optionally filtered results generated in block 255, are then displayed in block 205 as the process 120 returns to the beginning for another iteration. For example, the user may subsequently evaluate the newly generated unfiltered or filtered search results in block 215 to provide new feedback, and optionally modify one or more characteristics (genes) associated with a given item in the new search results, as indicated in block 220. Furthermore, now that at least one iteration of the process has been completed, the adaptive learning or trend analysis feature indicated in block 225 may be utilized based on comparing present user feedback to previous user feedback, and one or more evolutionary algorithms again may be performed in block 230, based on present (immediate) or cumulative feedback, and modified or unmodified genes associated with the new search results.

With reference again to FIG. 1, the interactive search process 120 discussed above in connection with FIG. 2 may, in one embodiment, be implemented with the aid of a conventional computer 115 (e.g., a personal computer, laptop, etc.) that includes a display 115-1 configured to convey information (e.g., search results) to the user 105, one or more selection devices 115-2 (e.g., a keyboard and/or mouse) configured to permit the user to interact with the process (e.g., evaluate the search results, modify genes, define filters or constraints), and one or more processors 115-3 configured to implement various steps or acts of the interactive search process 120.

In one exemplary implementation, the computer 115 includes a computer-readable medium 115-4 (e.g., various types of memory, compact disk, floppy disk, etc.) having computer-readable signals stored thereon that define instructions which, as a result of being executed by the one or more processors of the computer, instruct the computer to perform various steps or acts of the interactive search process 120. In another implementation, the interactive search process 120 is configured to “sit on top of” a conventional search component invoked by the user of the computer, by obtaining one or more characteristics or “genes” associated with a given item of information via the search component's API, and providing new search queries to the search component via its API.

According to various embodiments, the user may interact with the search process 120 via a number of possible techniques involving the display 115-1 and one or more selection devices 115-2. For example, as discussed above, information representing search results may be displayed on the display 115-1 in a variety of textual and/or graphical (e.g., iconic) formats. The user may utilize one or both of the display 115-1 and one or more of the selection devices 115-2 to click on/select/highlight various items of displayed information to provide some type of user feedback (e.g., assignment of subjective value to an item).

In one exemplary embodiment in which respective items of information are represented as images or diagrams surrounded by a border, a user may click on an item to change its evaluation between neutral (e.g., no border), positive (e.g., grey or some other color border) or negative (e.g., crossed out). In another embodiment, the user may obtain additional information about a particular item (e.g., characteristics or genes associated with the item) by letting a cursor hover over the image or diagram corresponding to the item or right clicking over the image or diagram corresponding to the item, for example. In yet another embodiment, an image or diagram corresponding to one or more items may be associated with a small slider, entry box, or pull-down/drop-down box, etc., displayed near or over the image or diagram. In the example of a slider, the user may adjust the slider with one of the selection devices to assign a subjective value to the item within a range of values from some minimum value to some maximum value represented on the slider. In the example of an entry box or pull-down/drop-down box, the user may manually enter a value from the keyboard, or select a value from amongst multiple possibilities conveyed by a menu. In yet another embodiment, the user may select a degree of randomness in generating new search queries through a slider representing two extremes labeled “Guide Me” and “Surprise Me,” corresponding respectively to low and high degrees of randomness. It should be appreciated that the foregoing examples are provided primarily for purposes of illustration, and that various embodiments of the present disclosure are not necessarily limited in these respects.

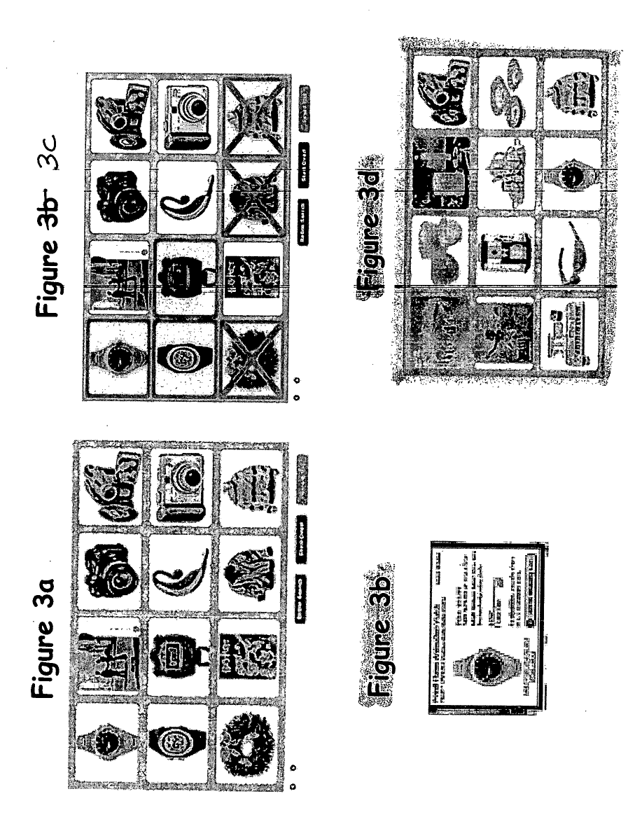

FIGS. 3a, 3b and 3c provide another illustrative embodiment of some of the concepts discussed above. FIG. 3a shows a set of items as a 4×3 grid, though other configurations are possible. The initial set of items may be generated by an initial search query. In FIG. 3b, the user may obtain additional information on any given item represented in the grid, such as price and availability, by letting the cursor hover over the item, and/or by right-clicking the item. In FIG. 3c, the user 105 can select, or click on, an particular item in order to change its evaluation between neutral (no border), positive (grey border) or negative (crossed out). FIG. 3d illustrates the results of a subsequent search query pursuant to the interactive search process 120, which may include the items selected by the user or similar items, but not include items indicated with a negative feedback by the user or similar items. The new search results also may include other random items the user has not seen, and/or other items similar to those the user has already seen but not evaluated. For example, in FIG. 3c, the user had given positive feedback to a watch and a camcorder, and negative feedback to an electronic keyboard and a set of dishes. The next selection in FIG. 3d includes additional watches and cameras, and additional items. In FIG. 3c, the user has given positive feedback to all the watches, and negative feedback to the clothes and the wreath, while leaving the camera equipment as neutral. By continuing in this fashion, the user will eventually converge on a specific item or set of items that is satisfactory.

Yet another exemplary embodiment implementing various concepts according to the present disclosure includes a web-based system that enables the user to select a venue for a vacation. When looking for a vacation, most Internet-bases search engines such as Orbitz™, travelocity®, and expedia.com® can offer information about specific hotels, resorts, etc., but require the user to have a clear idea of (e.g., to specify) a destination. In many cases, a person looking for a vacation destination may only have an approximate idea of a destination/time, e.g., “I want to spend one week in January someplace warm with my husband and two children.” With existing travel sites, the user has to select a geographical area, and look through a list of possible venues (e.g., selected on the basis of price range) to identify one with the desired characteristics. However, the user may initially have no idea of which particular geographical locations are satisfactory, and even if s/he has an idea of the geographical area (e.g., the Caribbean), s/he may not know which specific locations and which venues at that location satisfy her/his constraints.

Some online vacation sites allow a user to specify a number of criteria in a sequential fashion, for instance by starting with a specific location, then selecting price range, activity types, etc.; however, in this way, the search is narrowed unnecessarily and may cause a user to overlook some potentially suitable alternatives. For example, if a user begins by selecting the Caribbean, s/he may eventually identify a resort in Cancun, but there may have been other venues (e.g., Canary Islands) which have similar and perhaps more desirable characteristics, where such other venues which were not presented to the user after the initial decision.

In view of the foregoing, in one embodiment, the user is presented with a grid of images, each image being a picture representing one venue. Below each image may be a row of icons representing key characteristics of the property, such as cost, style (single, couple, family, . . . ), geographical location, etc. A second row below the image can include simple iconographic buttons that allow the user to obtain additional information in a pop-up window (e.g., view additional photos, read client reviews, determine availability), to provide evaluative feedback about the property (this can be as simple as a thumbs-up/thumbs-down pair, or a slider), to save this property to a folder representing the user's current selection portfolio, and/or to actually make a reservation at this property.

In one aspect of this embodiment, the display below the entire grid of images may include one or more buttons and sliders, including a button to generate a refined set of properties based on the user's feedback, a button to start with a fresh random set of properties, a slider labeled with the extreme values “Surprise me” and “Guide me” which determine the level of randomness of the search as described for the previous embodiment, a button that brings the user to her current portfolio of selections, and navigation buttons to trace backwards and forward through the selections made during a given search session.

In other aspects of this embodiment, an additional set of buttons, pull-down menus, radio buttons, and/or text entry boxes can be included. Through these various devices, the user can specify a filter, i.e., one or more constraints, that apply to all searched properties. For instance, if the user wants only family-oriented resorts by the sea, s/he can specify these criteria to ensure that inappropriate properties are not selected during search.

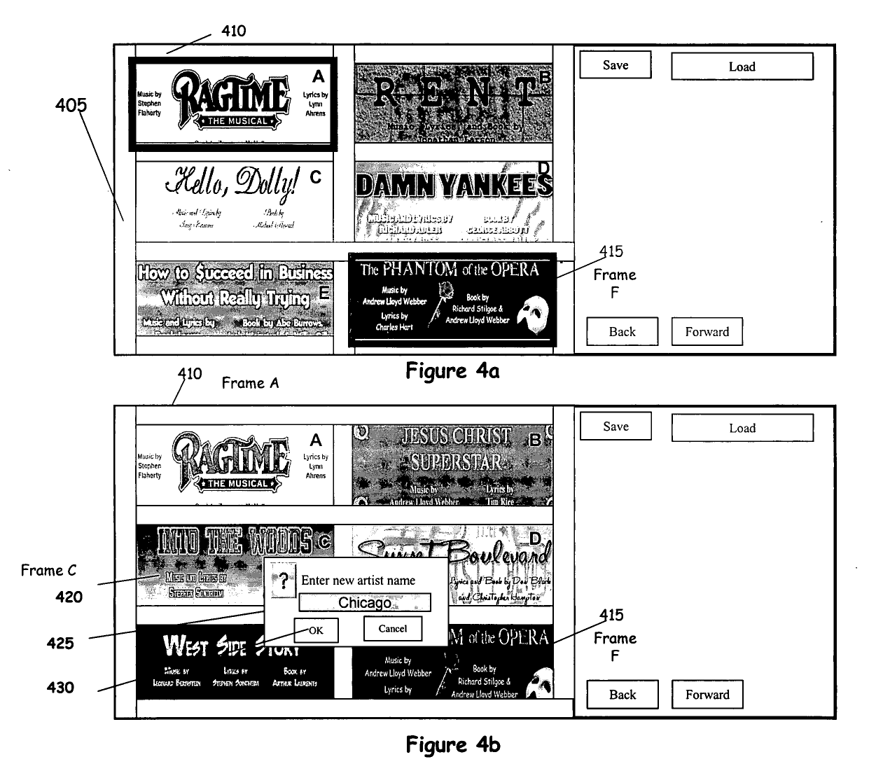

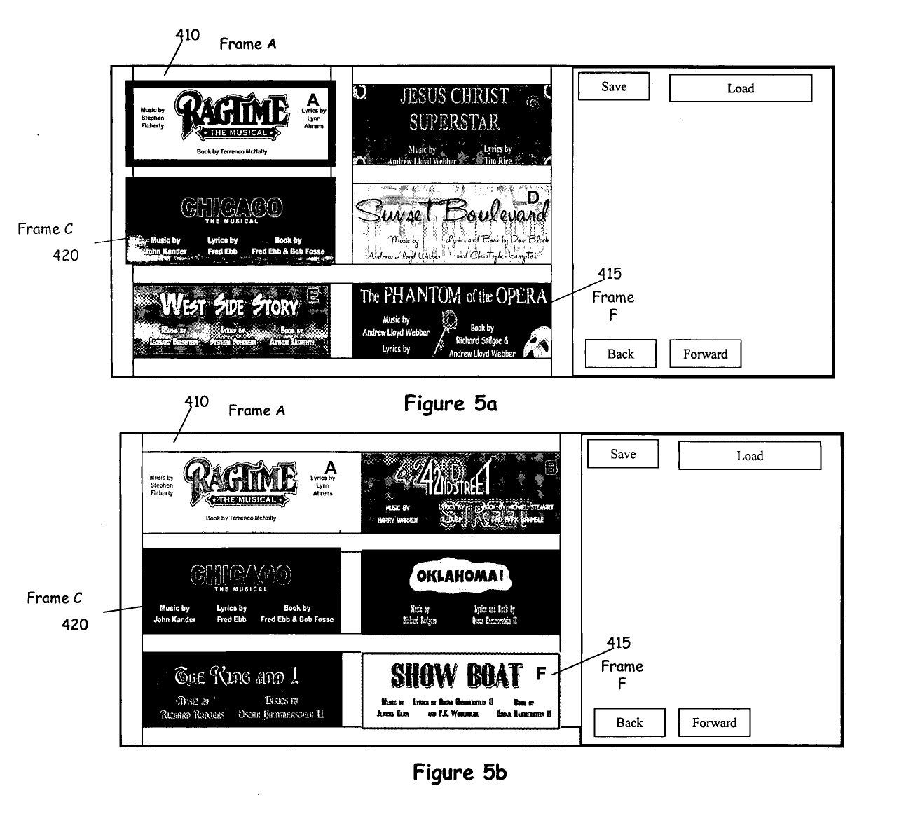

FIGS. 4 and 5 illustrate yet another exemplary embodiment of the present disclosure. In this embodiment, the interactive search process 120 discussed above in connection with FIG. 2 assists the user 105 to search for a music CD. For example, the user visits the Amazon.com website and searches under the CD section. Specifically, in this example, the user types “Broadway” in the search window and the Amazon search engine returns a selection 405 of search results, of which six are displayed in FIG. 4a.

Based on her personal preferences, the user selects Frame A 410 and Frame F 415 (as depicted by the striped frames). One or more evolutionary algorithms of the interactive search process 120 utilize the “genes” (e.g., tags) associated with the items in Frame A 410 and Frame F 415 and feed a new search query, based mutations and recombinations of the genes, into the Amazon search engine. The search engine generates a new population of search results (FIG. 4b) which presents CD options that combine implicit properties of Frame A 410 and Frame F 415. For example, the new population in FIG. 4b includes more musical selections by Andrew Lloyd Webber, the composer of the musical, namely Phantom of the Opera, in Frame F 415.

As shown in FIG. 4b, if the user so desires, she may right click on Frame C 420 and bring up a search box 425. The search box 425 allows the user to introduce a new theme to the search. In the illustrated embodiment, the user enters the new theme: “Chicago”; and then clicks an OK-button 430. A search based on the query “Chicago” is conducted for Frame C 420 and will be displayed on within Frame C 420.

FIG. 5a depicts Frame C 420 as being replaced with the musical “Chicago,” which was the search result for the query “Chicago.” The user can continue with the Interactive Search Process by selecting Frame A 410 and Frame C 420. This new search generates an offspring (e.g. mutation and recombination) that combines the genes (e.g., characteristics, tags) of these two new themes. As shown in FIG. 5b, the new search returns a new population, which results from the feeding of a search query based on mutated and recombined genes to the Amazon search engine. Oftentimes, these searches produce highly relevant combinations that the user typically may not have considered. One of the results, “Show Boat” (see Frame F 415) is an example of an usual but highly relevant combination of the musicals “Ragtime” and “Chicago.”

According to one aspect, the embodiment illustrated in FIGS. 4 and 5 may employ two distinct modes of evolution: Hill Climbing (HC) and Mutation and Crossover (MC). In the HC mode, the user selects only one item displayed and the search consists of mutating one or more of the item's genes. Mutation consists of deleting part of the genetic string; adding one or more random genes to the genetic string; or replacing part of the genetic string. HC is used to fine tune the search. In the MC mode, the user can select several displayed items and crossover is applied to those items by combining genes of the items' respective genetic strings. The resulting offspring genetic string is then mutated. A new search query based on the foregoing is then fed into the Amazon search engine, which in turn, generates new search results. All or a subset of the new search results is displayed to the user.

The embodiment illustrated in FIGS. 4 and 5 was implemented by using Amazon's APIs to interface with their search engine. However, a person skilled in the art would know that the described methods and apparatus may be applied to any existing search engine with an interface, such as Yahoo!

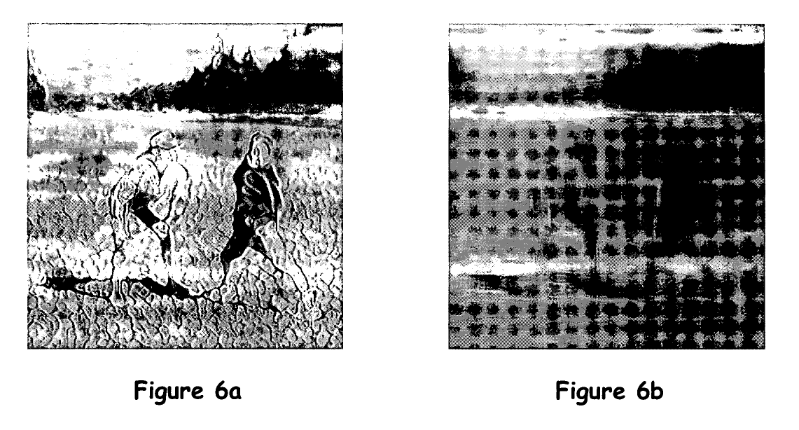

The disclosed methods and systems can additionally be used to identify a set of parameters or characteristics rather than selecting one item out of an existing set of items. Consider for example the process of modifying a digital image. Programs such as Photo-Shop or Paint Shop Pro provide the user with a large set of filters that alter the content of the image. For example, there are filters that can change contrast, brightness, tint, saturation and color balance. There are also many filters that apply artistic or geometric effects such as emboss, charcoal, paintbrush, leather, kaleidoscope, warp, solarize, mosaic, etc. Each of these filters typically is associated with one or more parameters that modify the extent or nature of the filter. For instance, FIG. 6a shows an original digital picture using Paint Shop Pro (v.7) to apply some artistic filters to the image. Paint Shop Pro (v.7) includes over 80 different filters, and many more third-party filters, with the ability to create user-defined filters. Of the 80 or so standard filters, most have multiple parameters that determine the strength and quality of the effect being applied. For instance, the “Rough Leather” effect is controlled by seven parameters: leather color, angle, luminance, contrast, sharpness, blur and light color. Each parameter admits many different values: if the colors are quantized to 16 bits (256 possible colors), the following number of settings for each parameter are achieved: leather color (256), angle (360), luminance (512), contrast (100), sharpness (100), blur (100) and light color (256). Accordingly, there are about 10¹⁶ possible combinations. Even if it is assumed that each parameter is only quantized to 16 values (4 bits), there are nearly 300 million combinations. Clearly, even if the user has decided to apply a single filter, it is impracticable to try even a small fraction of the possible variants of that filter. The complexity of the search grows exponentially if the user wants to apply multiple filters in sequence.

FIG. 6 illustrates the impact of filters and their parameters. FIG. 6a shows an original image. All other panels are generated using the Rough Leather filter with different parameter settings. In all cases, the leather color (yellow) and the light color (white) remained unchanged, and the modified parameters included the angle (A), luminance (L), contrast (C), sharpness (S) and blur (B). The accompanying Figures thus illustrate that small changes in a subset of the parameters can yield dramatically different results. Specifically, the five parameters were set as follows. FIG. 6b: A=270; L=0; C=0; S=30; B=10. FIG. 1c: A=90; L=10; C=20; S=0; B=0. FIG. 1d: A=45; L=10; C=0; S=50; B=50.

Accordingly, the problem of selecting filters and parameters can be understood to be a search problem that requires an understanding of the user's subjective evaluation, and that has a potentially vast set of results, as provided herein.

Another embodiment of the disclosed methods and systems presents the user with a grid of images. Images in the grid are generated by applying a randomly chosen effect filter with a random set of parameters. A separate panel shows the original image for comparison. Each image in the grid is associated with a set of buttons and sliders that enable to user to provide feedback on his/her subjective evaluation of that image, a button that allows the user to manually adjust parameters using the current image as a starting point, and/or a button/interface that allows the user to save the image to a folder.

Below the entire grid of images, the example embodiment includes buttons and sliders, including a button to generate a new set of images based on the user's feedback, a button to start with a fresh random set of images, a slider which determines the level of randomness of the search as described for previous embodiments, and navigation buttons to trace backwards and forward through the selections made during a given search session.

In additional embodiments, the items being searched might include any of the following: homes, automobiles, financial instruments (such as stocks or bonds), service providers, legal documents, scientific articles, art, images, web pages, recruitment candidates, potential employers, etc., with such examples provided for illustration and not limitation. In the context of selecting parameters, as was shown in the embodiment for selecting parameters for image effect filters, additional embodiments can be envisioned for design of mechanical systems, architectural elements, artistic designs, etc. The above are meant as partial lists, as various embodiments can be applied to any search in which the results come from a potentially vast set of choices.

As used herein, a “user interface” is an interface between a human user and a computer that enables communication between the user and the computer. A user interface may include an auditory indicator such as a speaker, and/or a graphical user interface (GUI) including one or more displays. A user interface also may include one or more selection devices including a mouse, a keyboard, a keypad, a track ball, a microphone, a touch screen, a game controller (e.g., a joystick), etc., or any combinations thereof.

As used herein, an “application programming interface” or “API” is a set of one or more computer-readable instructions that provide access to one or more other sets of computer-readable instructions that define functions, so that such functions can be configured to be executed on a computer in conjunction with an application program, in some instances to communicate various data, parameters, and general information between two programs.

The various methods, acts thereof, and various embodiments and variations of these methods and acts, individually or in combination, may be defined by computer-readable signals tangibly embodied on one or more computer-readable media, for example, non-volatile recording media, integrated circuit memory elements, or a combination thereof. Such signals may define instructions, for example, as part of one or more programs, that, as a result of being executed by a computer, instruct the computer to perform one or more of the methods or acts described herein, and/or various embodiments, variations and combination thereof. Such instructions may be written in any of a plurality of programming languages or using any of a plurality of programming techniques.

For example, various methods according to the present disclosure may be programmed using an object-oriented programming language. Alternatively, functional, scripting, and/or logical programming languages may be used. Various aspects of the disclosure may be implemented in a non-programmed environment (e.g., documents created in HTML, XML or other format that, when viewed in a window of a browser program, render aspects of a graphical-user interface (GUI) or perform other functions). Various aspects of the disclosure may be implemented as programmed or non-programmed elements, or combinations thereof.

A given computer-readable medium may be transportable such that the instructions stored thereon can be loaded onto any computer system resource to implement various aspects of the present disclosure. In addition, it should be appreciated that the instructions stored on the computer-readable medium are not limited to instructions embodied as part of an application program running on a host computer. Rather, the instructions may be embodied as any type of computer code (e.g., software or microcode) that can be employed to program a processor to implement various aspects of the present disclosure.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

What is claimed is:

1. A method, comprising acts of:
A) evaluating first information to provide first feedback on the first information; and
B) evaluating the first feedback using at least one evolutionary algorithm to generate a search query.

2. The method of claim 1, further comprising an act of:
randomly generating the first information.

3. The method of claim 1, further comprising an act of:
C) executing a previous search query to provide the first information.

4. The method of claim 3, wherein the act C) comprises an act of:
executing the previous search query using a search engine.

5. The method of claim 4, wherein the search engine is provided by one of the following sources: Yahoo!®, MSN®, Google™, amazon.com®, a9.com, AOL®, Lycos®, LookSmart®, Altavista™, Ask Jeeves®, Orbitz™, travelocity®, expedia.com®, and Flickr™.

6. The method of claim 3, wherein the act C) comprises an act of:
executing the previous search query using a web directory service.

7. The method of claim 6, wherein the web directory service includes the Open Directory Project.

8. The method of claim 1, wherein the first information includes a plurality of items, and wherein the plurality of items includes one of a plurality of goods for purchase and a plurality of services for purchase.

9. The method of claim 1, wherein the first information includes a plurality of items, and wherein the method comprises an act of:
D) providing at least one perceivable indication representing at least one of the plurality of items.

10. The method of claim 9, wherein the act D) comprises an act of:
providing at least one audible indication representing at least one of the plurality of items.

11. The method of claim 9, wherein the act D) comprises an act of:
D1) providing at least one visible indication representing at least one of the plurality of items.

12. The method of claim 11, wherein the act D1) comprises an act of:
textually displaying the plurality of items.

13. The method of claim 11, wherein the act D1) comprises an act of:
D1a) graphically displaying the plurality of items.

14. The method of claim 13, wherein the act D1a) comprises an act of:
D1a1) graphically displaying the plurality of items as a plurality of images or diagrams.

15. The method of claim 14, wherein the act D1a1) comprises an act of:
graphically displaying the plurality of items as a grid of images or diagrams.

16. The method of claim 1, wherein the first information includes a plurality of items, and wherein the act A) comprises an act of:
A1) assigning a degree of randomness based on evaluating the plurality of items to provide the first feedback.

17. The method of claim 1, wherein the first information includes a plurality of items, and wherein the act A) comprises an act of:
A1) assigning a subjective value to at least one item of the plurality of items to provide the first feedback.

18. The method of claim 17, further comprising acts of:
E) providing a plurality of visible indications representing the plurality of items; and
F) representing on at least one of the plurality of visible indications the subjective value assigned to the at least one item of the plurality of items.

19. The method of claim 18, wherein:
the act E) comprises an act of graphically displaying the plurality of items as a grid of images or diagrams; and
the act F) comprises an act of representing on the grid of images or diagrams the subjective value assigned to the at least one item of the plurality of items.

20. The method of claim 17, wherein the act A1) comprises an act of:
A1a) selecting the subjective value from at least two possible subjective values.

21. The method of claim 20, wherein the at least two possible subjective values include a positive value, a negative value and a neutral value, and wherein the act A1a) comprises an act of:
selecting the subjective value as one of the positive value, the negative value, and the neutral value.

22. The method of claim 20, wherein the at least two possible subjective values include a range of possible subjective values between a minimum value and a maximum value, and wherein the act A1a) comprises an act of:
selecting the subjective value from within the range of possible subjective values.

23. The method of claim 17, wherein the act A1) comprises an act of:
assigning respective subjective values to at least two items of the plurality of items to provide the first feedback.

24. The method of claim 23, wherein each item of the first information is associated with at least one characteristic, and wherein the act B) comprises an act of:
B1) applying the at least one evolutionary algorithm to the at least one characteristic associated with each item of the at least two items, based on the respective subjective values assigned to the at least two items, to generate the search query.

25. The method of claim 24, wherein the act B1) comprises acts of:
B1a) encoding the at least one characteristic associated with each item as a genetic string associated with each item; and
B1b) applying the at least one evolutionary algorithm to the genetic strings respectively associated with the at least two items, based on the respective subjective values assigned to the at least two items, to generate the search query.

26. The method of claim 25, further comprising an act of:
executing a previous search query using a search engine to provide the first information,
wherein the at least one characteristic associated with each item comprises any descriptor made available by the search engine.

27. The method of claim 25, wherein the at least one characteristic associated with each item comprises at least one tag.

28. The method of claim 27, wherein the at least one tag comprises at least one of a keyword, a comment, a URL link and XML information.

29. The method of claim 25, wherein the at least one characteristic associated with each item comprises at least one of:
at least one keyword;
at least one classification-oriented identifier;
at least one categorization-oriented identifier; and
at least one semantic web-oriented identifier.

30. The method of claim 29, wherein the at least one characteristic associated with each item comprises at least one of:
at least one taxonomy-related identifier;
at least one ontology-related identifier; and
at least one folksonomy-related identifier.

31. The method of claim 25, wherein the act B1b) comprises an act of applying at least one of the following genetic operators to the genetic strings respectively associated with the at least two items:
a selection operator;
a mutation operator;
a recombination operator;
a crossover operator;
a directed operator;
a constraint operator; and
a preservation operator.

32. The method of claim 23, wherein each item of the first information is associated with at least one characteristic, and wherein the act B) comprises acts of:
B1) modifying at least one characteristic associated with at least one item of the at least two items; and
B2) applying the at least one evolutionary algorithm to the at least one modified characteristic associated with the at least one item of the at least two items, based on the respective subjective values assigned to the at least two items, to generate the search query.

33. The method of claim 32, wherein:
the act B1) comprises an act of encoding the at least one modified characteristic associated with the at least one item as a genetic string associated with the at least one item; and
the act B2) comprises an act of applying the at least one evolutionary algorithm to the genetic string including the at least one modified characteristic associated with the at least one item, based on the respective subjective values assigned to the at least two items, to generate the search query.

34. The method of claim 1, further comprising an act of:
G) executing the search query to provide second information.

35. The method of claim 34, wherein the act G) comprises an act of:
executing the search query using a search engine.

36. The method of claim 35, wherein the search engine is provided by one of the following sources: Yahoo!®, MSN®, Google™, amazon.com®, a9.com, AOL®, Lycos®, LookSmart®, Altavista™, Ask Jeeves®, Orbitz™, travelocity®, expedia.com®, and Flickr™.

37. The method of claim 35, wherein the act G) comprises an act of:
executing the search query using a web directory service.

38. The method of claim 37, wherein the web directory service includes the Open Directory Project.

39. The method of claim 34, further comprising an act of:
evaluating the second information to provide second feedback on the second information.

40. The method of claim 39, further comprising an act of:
evaluating the second feedback using at least one evolutionary algorithm to generate a second search query.

41. The method of claim 39, further comprising acts of:
generating third feedback based at least in part on the first feedback and the second feedback; and
evaluating the third feedback using at least one evolutionary algorithm to generate a second search query.

42. The method of claim 41, wherein the act of generating the third feedback comprises an act of generating the third feedback based on a trend derived from the first feedback and the second feedback.

43. The method of claim 34, further comprising an act of:
filtering the second information to provide filtered second information.

44. The method of claim 43, wherein the act of filtering the second information comprises an act of applying at least one constraint to the second information to provide the filtered second information.

45. The method of claim 43, further comprising an act of:
evaluating the filtered second information to provide second feedback on the filtered second information.

46. The method of claim 45, further comprising an act of:
evaluating the second feedback using at least one evolutionary algorithm to generate a second search query.

47. The method of claim 45, further comprising acts of:
generating third feedback based at least in part on the first feedback and the second feedback; and
evaluating the third feedback using at least one evolutionary algorithm to generate a second search query.

48. The method of claim 47, wherein the act of generating the third feedback includes an act of generating the third feedback based on a trend derived from the first feedback and the second feedback.

49. The method of claim 1, further comprising acts of:
H) modifying the search query generated in the act B); and
I) executing the modified search query to provide second information.

50. The method of claim 49, further comprising an act of:
evaluating the second information to provide the second feedback on the second information.

51. The method of claim 50, further comprising an act of:
evaluating the second feedback using at least one evolutionary algorithm to generate a second search query.

52. The method of claim 50, further comprising an act of:
filtering the second information to provide filtered second information.

53. The method of claim 52, further comprising an act of:
evaluating the filtered second information to provide second feedback on the filtered second information.

54. The method of claim 53, further comprising an act of:
evaluating the second feedback using at least one evolutionary algorithm to generate a second search query.

55. A computer-readable medium having computer-readable signals stored thereon that define instructions which, as a result of being executed by a computer, instruct the computer to perform a method comprising acts of:
A) permitting a user to evaluate first information to provide first feedback on the first information; and
B) evaluating the first feedback using at least one evolutionary algorithm to generate a search query.

56. In a computer system having a user interface including a display and a selection device, a method comprising acts of:
A) displaying first information on the display;
B) permitting a user to evaluate the first information via the selection device to provide first feedback on the first information; and
C) evaluating the first feedback using at least one evolutionary algorithm to generate a search query.

57. A system, comprising:
at least one first component configured to convey first information to a user;
at least one second component configured to permit the user to evaluate the first information to provide first feedback on the first information; and
at least one processor configured to evaluate the first feedback using at least one evolutionary algorithm to generate a search query.

58. A search method, comprising acts of:
A) executing a first search query to generate first information, the first information including a plurality of items, each item of the plurality of items being associated with at least one characteristic;
B) encoding the at least one characteristic associated with each item as at least one gene of a genetic string associated with each item;
C) permitting a user to assign a subjective value to at least one item of the plurality of items to provide first feedback;
D) applying at least one evolutionary algorithm to at least the genetic string associated with the at least one item, based on the first feedback, to generate a second search query; and
E) executing the second search query to generate second information.

59. The method of claim 58, wherein the first information includes a plurality of items, and wherein the plurality of items includes one of a plurality of goods for purchase and a plurality of services for purchase.

60. The method of claim 58, wherein the acts A) and E) are performed by a search engine.

61. The method of claim 60, wherein the search engine is provided by one of the following sources: Yahoo!®, MSN®, Google™, amazon.com®, a9.com, AOL®, Lycos®, LookSmart®, Altavista™, Ask Jeeves®, Orbitz™, travelocity®, expedia.com®, and Flickr™.

62. The method of claim 58, wherein the acts A) and E) are performed by a web directory service.

63. The method of claim 62, wherein the web directory service includes the Open Directory Project.

64. The method of claim 58, wherein the act A) comprises an act of:
A1) providing at least one visible indication representing at least one of the plurality of items.

65. The method of claim 64, wherein the act A1) comprises an act of:
A1a) graphically displaying the plurality of items as a plurality of images or diagrams.

66. The method of claim 64, wherein:
the act A1) comprises an act of Ala) providing a plurality of visible indications representing the plurality of items; and
the act C) further comprises an act of C1) representing on at least one of the plurality of visible indications the subjective value assigned to the at least one item of the plurality of items.

67. The method of claim 66, wherein:
the act A1a) comprises an act of graphically displaying the plurality of items as a grid of images or diagrams; and
the act C1) comprises an act of representing on the grid of images or diagrams the subjective value assigned to the at least one item of the plurality of items.

68. The method of claim 58, wherein the act C) comprises an act of:
permitting the user to select the subjective value from a range of possible subjective values.

69. The method of claim 58, wherein the at least one characteristic associated with each item comprises at least one descriptor made available by a search engine or web directory service, and wherein the act B) comprises an act of:
encoding the at least one descriptor as the at least one gene of the genetic string associated with each item

70. The method of claim 58, wherein the at least one characteristic associated with each item comprises at least one tag, and wherein the act B) comprises an act of:
encoding the at least one tag as the at least one gene of the genetic string associated with each item.

71. The method of claim 70, wherein the at least one tag comprises at least one of a keyword, a comment, a URL link and XML information.

72. The method of claim 58, wherein the at least one characteristic associated with each item comprises at least one of:
at least one keyword;
at least one classification-oriented identifier;
at least one categorization-oriented identifier; and
at least one semantic web-oriented identifier.

73. The method of claim 72, wherein the at least one characteristic associated with each item comprises at least one of:
at least one taxonomy-related identifier;
at least one ontology-related identifier; and
at least one folksonomy-related identifier.

74. The method of claim 58, wherein the act B) comprises acts of:
permitting the user to modify at least one characteristic associated with at least one item; and
encoding the at least one modified characteristic as at least one gene of a genetic string associated with the at least one item.

75. The method of claim 58, wherein the evolutionary algorithm includes at least one of the following genetic operators:
a selection operator;
a mutation operator;
a recombination operator;
a crossover operator;
a directed operator;
a constraint operator; and
a preservation operator.

76. The method of claim 58, wherein the at least one evolutionary algorithm includes at least one mutation operator configured to delete at least one gene of a given genetic string or add at least one random gene to the given genetic string, and wherein the act D) comprises an act of:
applying the at least one mutation operator to at least the genetic string associated with the at least one item to generate the second search query.

77. The method of claim 58, wherein:
the act C) comprises an act of:
C1) permitting the user to assign respective subjective values to at least two items of the plurality of items to provide the first feedback; and
the act D) comprises an act of:
D1) applying the at least one evolutionary algorithm to at least the genetic strings respectively associated with the at least two items, based on the first feedback, to generate the second search query.

78. The method of claim 77, wherein the at least one evolutionary algorithm comprises at least one crossover operator configured to combine genes of at least two given genetic strings to produce an offspring, and at least one mutation operator configured to delete at least one gene of a given genetic string or add at least one random gene to the given genetic string, and wherein the act D1) comprises acts of:
applying the at least one crossover operator to at least the genetic strings respectively associated with the at least two items to generate the offspring; and
applying the at least one mutation operator to the offspring to generate the second search query.

79. The method of claim 58, further comprising an act of:
permitting the user to evaluate the second information to provide second feedback on the second information.

80. The method of claim 79, further comprising an act of:
evaluating the second feedback using at least one evolutionary algorithm to generate a third search query.

81. The method of claim 79, further comprising acts of:
generating third feedback based at least in part on the first feedback and the second feedback; and
evaluating the third feedback using at least one evolutionary algorithm to generate a third search query.

82. The method of claim 81, wherein the act of generating the third feedback comprises an act of generating the third feedback based on a trend derived from the first feedback and the second feedback.

83. The method of claim 58, further comprising an act of:
filtering the second information to provide filtered second information.

84. The method of claim 83, wherein the act of filtering the second information comprises an act of applying at least one constraint to the second information to provide the filtered second information.

85. The method of claim 83, further comprising an act of:
evaluating the filtered second information to provide second feedback on the filtered second information.

86. The method of claim 85, further comprising an act of:
evaluating the second feedback using at least one evolutionary algorithm to generate a third search query.

87. The method of claim 85, further comprising acts of:
generating third feedback based at least in part on the first feedback and the second feedback; and
evaluating the third feedback using at least one evolutionary algorithm to generate a third search query.

88. The method of claim 87, wherein the act of generating the third feedback includes an act of generating the third feedback based on a trend derived from the first feedback and the second feedback.

89. The method of claim 58, wherein:
the act D) comprises an act of permitting the user to modify the second search query; and
the act E) comprises an act of executing the modified second search query to provide the second information.

90. The method of claim 89, further comprising an act of:
evaluating the second information to provide second feedback on the second information.

91. The method of claim 90, further comprising an act of:
evaluating the second feedback using at least one evolutionary algorithm to generate a second search query.

92. The method of claim 90, further comprising an act of:
filtering the second information to provide filtered second information.

93. The method of claim 92, further comprising an act of:
evaluating the filtered second information to provide second feedback on the filtered second information.

94. The method of claim 93, further comprising an act of:
evaluating the second feedback using at least one evolutionary algorithm to generate a third search query.

95. A computer-readable medium having computer-readable signals stored thereon that define instructions which, as a result of being executed by a computer, instruct the computer to perform a search method comprising acts of:
A) executing a first search query to generate first information, the first information including a plurality of items, each item of the plurality of items being associated with at least one characteristic;
B) encoding the at least one characteristic associated with each item as at least one gene of a genetic string associated with each item;
C) permitting a user to assign a subjective value to at least one item of the plurality of items to provide first feedback;
D) applying at least one evolutionary algorithm to at least the genetic string associated with the at least one item, based on the first feedback, to generate a second search query; and
E) executing the second search query to generate second information.

96. In a computer system having a user interface including a display and a selection device, a search method comprising acts of:
A) executing a first search query to generate first information, the first information including a plurality of items, each item of the plurality of items being associated with at least one characteristic;
B) encoding the at least one characteristic associated with each item as at least one gene of a genetic string associated with each item;
C) displaying the first information on the display;
D) permitting a user to assign, via at least the selection device, a subjective value to at least one item of the plurality of items to provide first feedback;
E) applying at least one evolutionary algorithm to at least the genetic string associated with the at least one item, based on the first feedback, to generate a second search query; and
F) executing the second search query to generate second information.

97. A system, comprising:
a search component configured to execute a first search query to generate first information, the first information including a plurality of items, each item of the plurality of items being associated with at least one characteristic;
a first component configured to convey the first information to a user;
a second component configured to permit the user to assign a subjective value to at least one item of the plurality of items to provide first feedback; and
at least one third component configured to:
encode the at least one characteristic associated with each item as at least one gene of a genetic string associated with each item; and
apply at least one evolutionary algorithm to at least the genetic string associated with the at least one item, based on the first feedback, to generate a second search query,
wherein the search component is further configured to execute the second search query to generate second information.
